(19) United States
(12) Patent Application Publication
(10) Pub. No.: US 2022/0036369 A1
(43) Pub. Date: Feb. 3, 2022

(54) INTELLIGENTLY GUIDING A CUSTOMER ALONG A SERVICE ENGAGEMENT PATH USING AN AI/ML PATH GUIDANCE MODEL

(71) Applicant: Dell Products L. P., Round Rock, TX (US)

(72) Inventors: Karthik Ranganathan, Round Rock, TX (US); Anish Arora, Round Rock, TX (US); Vasudev Ka, Bangalore (IN); Amit Sawhney, Round Rock, TX (US); Sathish Kumar Bikumala, Round Rock, TX (US); Shalu Singh, Round Rock, TX (US)

(21) Appl. No.: 16/942,007

(22) Filed: Jul. 29, 2020

(51) Int. Cl. G06Q 30/00; G06N 20/00; G06K 9/62

(52) U.S. Cl. CPC G06Q 30/016; G06K 9/6267; G06N 20/00

(57) ABSTRACT

A system to intelligently guide a customer along a service engagement path is disclosed. In certain embodiments, a customer persona for the customer is determined as well as the current location of the customer in a process interaction along the service engagement path. The customer persona of the customer and current location of the customer along the service engagement path may be provided to an Artificial Intelligence/Machine Learning (AI/ML) path guidance model. Intelligent guidance data is received from the AI/ML path guidance model, where the intelligent guidance data corresponds to a suggested location along the service engagement path based on the customer persona and current location of the customer along the service engagement path. The customer is directed to the suggested location in the service engagement path.

### BACKGROUND OF THE INVENTION

### Field of the Invention

The present invention is generally directed to computer systems used by a customer in engaging a service entity. More particularly, the present invention is directed to intelligently guiding a customer along a service engagement path using an AI/ML path guidance model.

### DESCRIPTION OF THE RELATED ART

As the value and use of information continues to increase, individuals and businesses seek additional ways to process and store information. One option available to users is information handling systems (IHS). An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

IHS can be used by service centers to resolve problems experienced by their customers. Some IHS used by the service centers may automatically guide a customer along a predetermined path to resolve their issues.

### SUMMARY OF THE INVENTION

A system of one or more computers can be configured to perform particular operations or actions by virtue of having software, firmware, hardware, or a combination of them installed on the system that in operation causes or cause the system to intelligently guide a customer along a service engagement path. In certain embodiments, a customer persona for the customer is determined as well as the current location of the customer in a process interaction along the service engagement path. The customer persona of the customer and current location of the customer along the service engagement path may be provided to an Artificial Intelligence/Machine Learning (AI/ML) path guidance model. Intelligent guidance data is received from the AI/ML path guidance model, where the intelligent guidance data corresponds to a suggested location along the service engagement path based on the customer persona and current location of the customer along the service engagement path. The customer is directed to the suggested location in the service engagement path. Other embodiments of this aspect include corresponding computer systems, apparatus, and computer programs recorded on one or more computer storage devices, each configured to perform the actions of the methods.

At least one embodiment includes determining a customer intent for engaging the service engagement path; and providing the customer intent, customer persona, and current location of the customer and the service engagement path to the AI/ML path guidance model to generate the intelligent guidance data. In at least one embodiment, the customer intent is determined by an AI/ML customer intent model configured to determine customer intent based on one or more of a customer browsing history, customer system information, machine-to-machine telemetry between customer systems, and past resolutions of problems encountered by the customer. In at least one embodiment, the customer persona corresponds to classifications identified in an unsupervised learning operation executed on historical customer service transaction data. In at least one embodiment, the service engagement path includes locations at which various communication channels are used by the customer to contact an entity for a service request. In at least one embodiment, the intelligent guidance data from the AI/ML path guidance model corresponds to a suggested location along a further service engagement path that is discontinuous with the service engagement path on which the customer is located.

### BRIEF DESCRIPTION OF THE DRAWINGS

The present disclosure may be better understood, and its numerous objects, features, and advantages made apparent to those skilled in the art by referencing the accompanying drawings. The use of the same reference number throughout the several figures designates a like or similar element.

FIG. 1 is a generalized illustration of an information handling system that is configured to implement certain embodiments of the system and method of the present disclosure.

FIG. 2 is an exemplary block diagram showing one manner of determining and classifying customer persona.

FIG. 3 is a graphic showing examples of customer personas and corresponding attributes.

FIG. 4 is a functional diagram of an exemplary embodiment of an AI/ML customer intent model.

FIG. 5 is a functional diagram depicting the operation of an exemplary embodiment of a trained AI/ML path guidance model.

FIG. 6A through FIG. 6C depict various manners in which certain embodiments of the disclosed system direct different customers along a process path.

FIG. 7A through FIG. 7D depict various manners in which certain embodiments of the disclosed system direct different customers along a process path.

FIG. 8 depicts a Random Forest model that may be used to implement, for example, an AI/ML path guidance model.

FIG. 9 is a flowchart showing exemplary operations that may be executed in certain embodiments of the disclosed system.

### DETAILED DESCRIPTION

Certain embodiments of the disclosed system are implemented with the recognition that currently available customer service systems direct customers along a fixed path to resolve a given issue. The customers are directed along the fixed path, notwithstanding the prior interactions that the customer had as the customer proceeds along a service engagement path.

Certain embodiments of the disclosed system are also implemented with the recognition that a customer who is trying to troubleshoot an issue on the service system website may experience difficulty in finding the exact information customer is looking for to solve the customer's issues. For example, the single service path solution does not often take the technical capability and skills of the customer into account in formulating the service engagement path. In furtherance of this example, when a customer is trying to self diagnose the issue on the service provider's website, actions may be taken after the customer has spent a predetermined time on the site or a webpage. When this occurs, for example, the customer may be shown a chat box with generic text. Additionally, or in the alternative, the customer may proceed to further self navigate to pages the customer believes would solve their problem. These actions are taken in existing systems without reference to who the customer is and what the customer is looking for.

Certain embodiments of the disclosed system intelligently employ Artificial Intelligence/Machine Learning (AI/ML) techniques to customize the customer's engagement along the service engagement path. In certain embodiments, the disclosed system intelligently maps the customer's journey on the service provider's website. For example, certain embodiments of the disclosed system retrieve data that conveys the needs of the customer engaging the service center. For example, the customer's system information, which may be the subject of the service request may be provided, for example, using telemetry data connecting the customer's system with the service center. Additionally, or on the alternative, some embodiments may use the customer's persona information to identify service engagement paths based on the service engagement paths taken by other customers having similar persona. Additionally, or in the alternative, the intent of the customer may be used to intelligently guide the customer along the service engagement path. Certain embodiments of the disclosed system provide a personalized troubleshooting experience by prescribing the next best action recommendations or the most probable solution for the customer's issue.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of non-volatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

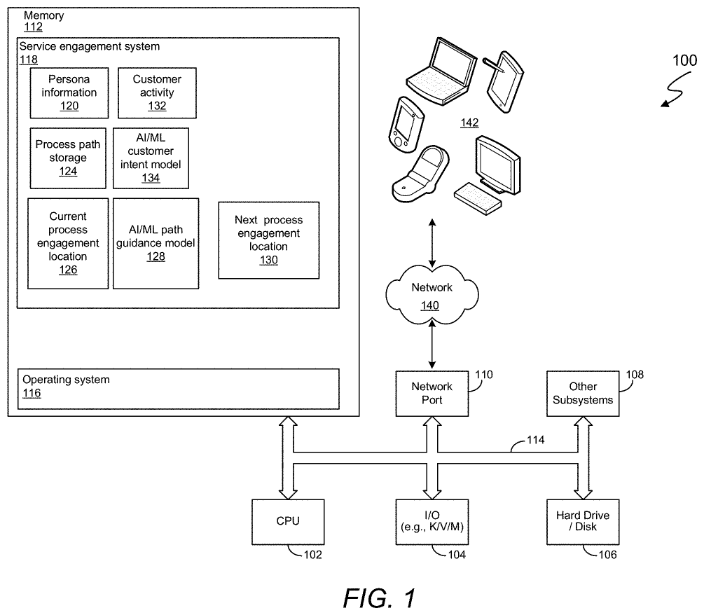

FIG. 1 is a generalized illustration of an information handling system 100 that is configured to implement certain embodiments of the system and method of the present disclosure. The IHS 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the IHS 100 also includes network port 110 operable to connect to a network 140. In certain embodiments, the system may be accessible by a plurality of customers using customer devices 142.

The IHS 100 likewise includes system memory 112, which is interconnected to the foregoing via one or more buses 114 or other suitable means. System memory 112 further comprises an operating system 116 and, in various embodiments, may also comprise other software modules and engines configured to implement certain embodiments of the disclosed system. Memory 112 may include memory that is accessed locally at the IHS 100 and/or memory that is distributed amongst one or more memory devices, storage systems, and/or memory accessible at other information handling systems within a networked environment.

FIG. 1 is shown and described with respect to certain functional blocks and engines that may be implemented in hardware, software, or a combination thereof. Although described with respect to a single IHS 100, the disclosed system may be implemented in one or more information handling systems. The one or more IHS may include, collectively or individually, a processor and a data bus coupled to the processor as, for example, shown in FIG. 1. One or more of the IHS may include non-transitory, computer-readable storage medium embodying computer program code. The non-transitory, computer-readable storage medium may be coupled to the data bus so that the computer program code included in one or more of the IHS is executable by the processor of the IHS so that the IHS, alone or in combination with other IHS, executes operations that implement a system and method for intelligently guiding a customer along a service engagement path using an AI/ML path guidance model.

In the example shown in FIG. 1, memory 112 includes a service engagement system 118 comprised of a plurality of functional modules and engines to intelligently guide a customer along a customer engagement path to obtain customer service from a service provider. As shown, the service engagement system 118 includes persona information 120 that may be used to classify a customer into persona classifications. As used herein, persona classifications group customers having similar characteristics for the purposes of intelligently guiding the customer along the customer engagement path.

Certain embodiments of the service engagement system 118 include process paths storage 124 that define paths that a customer may take while engaging the customer service system. The process paths defined in process paths storage 124 are generic paths such that every customer seeking to obtain a resolution to a problem proceeds sequentially along the same process path without regard to knowledge of the characteristics or needs of the user. In one example, in a process path defined as A−>B−>C−>D−>E−>F−>G, if a customer wishes to resolve an issue that would normally be solved at path location G, the customer would need to proceed through each of the locations from A to G. In certain embodiments, the IHS 100 may be dedicated to a particular defined sequential process path to resolve particular types of customer issues. Additionally, or in the alternative, the IHS 100 may be configured to service customers with different issues using a sequential process path dedicated to the resolution of each issue.

Certain embodiments of the service engagement system 118 include storage for the current process engagement location 126. In the example shown in FIG. 1, the current process engagement location 126 identifies the location at which the customer is currently engaged on the process path the customer is traveling.

FIG. 1 employs an AI/ML path guidance model 128 to intelligently select the next process location to which the customer should travel based on one or more of customer characteristics, customer persona, customer intent, and/or a current location in the process path. The next process engagement location 130 intelligently identifies the next location to which the customer should proceed based on one or more of the foregoing customer attributes. In many instances, the AI/ML path guidance model 128 may suggest that the customer skip several locations along the process path, return to a process location that the inventor has already seen, switch to a different process path, etc.

The AI/ML path guidance model 128 accesses the persona information 120 and current process engagement location 126. The process paths that are defined in the IHS may be accessed by the AI/ML path guidance model 128 from process paths storage 124. Additionally, or in the alternative, the AI/ML path guidance model 128 may be trained with substantially all process paths defined in IHS 100 thereby substantially eliminating the need of the AI/ML path guidance model 128 as a separately accessible set of data (e.g., process paths in 124).

Certain embodiments of the AI/ML path guidance model 128 use the customer intent in determining the next process engagement location 130. Customer intent may be based on customer attributes that indicate why the customer is engaging the customer service system. As one example, a customer may express an intent to locate information on the customer service system. As another example, the customer may express an intent to return and/or exchange a product. As another example, the customer may express an intent to request an on-site service. These examples constitute a few non-limiting reasons a customer engages the customer service system.

There are a number of customer actions that may be used to determine customer intent. Therefore, in certain embodiments, the customer intent may be intelligently determined using AI/ML customer intent model 134. In certain embodiments, the AI/ML customer intent model 134 is trained to recognize customer activity 132. In one example, the initial actions of the customer during the customer service session may be analyzed to determine intent. As an example, the customer may navigate through a path in which certain pages relate to the purchase of an item. As such, the AI/ML customer intent model 134 may provide an output indicating that the customer has an intent to purchase. In certain embodiments, past customer activity may be used to ascertain customer intent. For example, if a customer has often elected in the past to proceed along a path relating to the repair of an item, the AI/ML customer intent model 134 may provide an output indicating that the customer intent is to find a solution to repair an item. Other customer intents and corresponding factors identifying customer intents may be used, the foregoing representing non-limiting examples.

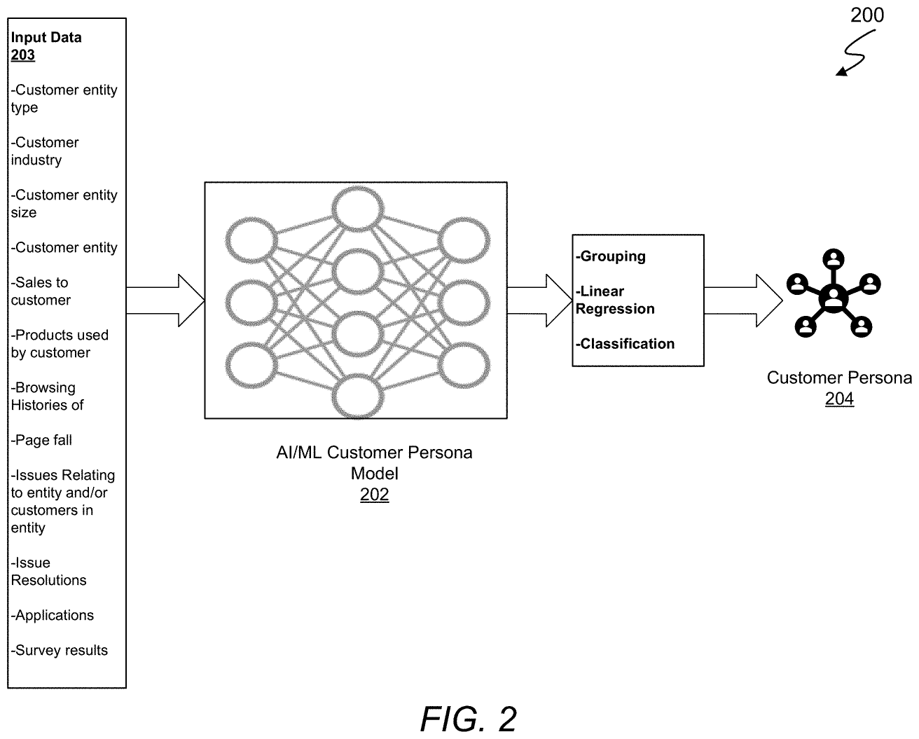

FIG. 2 is an exemplary block diagram 200 showing one manner of determining and classifying customer persona 204. In this example, an AI/ML customer persona model 202 operates using unsupervised learning. Input data 203 to the AI/ML customer persona model 202, may include but is not limited to 1) customer entity type, 2) customer entity industry, 3) customer entity size, 4) customer entity revenue, 5) sales made to customer entity, 6) products used by customer entity, 7) browsing history of the customers in the entity, 8) page fall out of the entity and/or individuals within the entity, 9) issues occurring within the entity and/or occurring with individual customers within the entity, 10) resolutions of issues, 11) applications used by the entity and/or individuals within the entity, and/or 12) survey results received from the entity and/or individuals within the entity. It will be recognized, in view of the teachings of the present disclosure, that the AI/ML customer persona model 202 may use a variety of information in determining customer persona 204.

In certain embodiments, the AI/ML customer persona model 202 provides an output of clusters or groups that may be used to define different persona. Accordingly, the development of the customer persona 204 involves grouping of data, linear regression analysis of the data, and classification of the customer persona groups. Once the customer persona groups have been classified, selected attributes of a customer seeking service may be provided to a trained AI/ML persona model to provide customer persona information that can be used to guide the customer along paths.

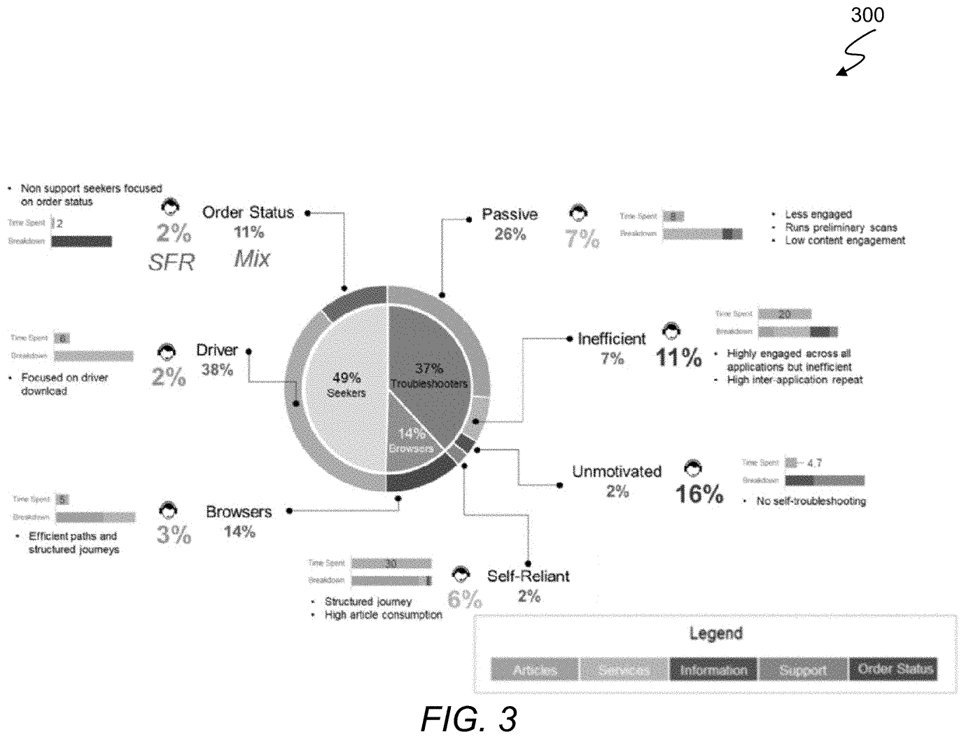

FIG. 3 is a graphic 300 showing examples of customer personas and corresponding attributes. In this example, there are three general persona groups shown here as seekers (49%), troubleshooters (37%), and browsers (14%). Each of the general persona groups may be further grouped based on a breakdown of the customer's activity and the time spent by the individual on the activity. Here, the three general persona groups include seven, more specific persona groups. A breakdown of the activities of the customers and the corresponding time spent by the customer on the activities is shown adjacent to each persona group. In this example, the persona groups include 1) customers typically seeking order status (11%), 2) customer seeking to download a driver (38%), 3) customers who follow a structured journey through the customer service site (14%), 4) customers that are self-relying by following the structured journey and consuming a high number of articles (2%), 5) unmotivated customers that do not have a history of self-troubleshooting (16%), 6) inefficient customers who are highly engaged across all applications but not efficient since they tend to frequently repeat interactions (11%), and 7) passive customers who are less engaged with the customer service site (26%). It will be recognized, based on the teachings of the present disclosure, that the classifications shown in FIG. 3 are merely illustrative, non-limiting examples. The classifications in some embodiments will vary based on the algorithms used by the AI/ML customer persona model 202 and the input data 203.

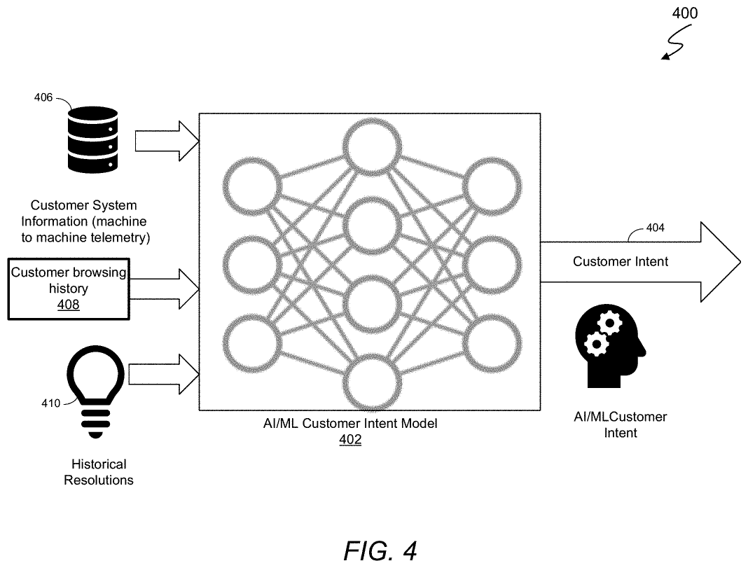

FIG. 4 is a functional diagram 400 of an exemplary embodiment of an AI/ML customer intent model 402. In this example, the AI/ML customer intent model 402 is trained to provide data 404 defining customer intent based on current and historical customer actions. In certain embodiments, the AI/ML customer intent model 402 provides a measure of the mindset of the customer and the likely reason that the customer is seeking customer assistance. In certain embodiments, the AI/ML customer intent model 402 receives system information data 406 corresponding to the systems used by the customer. For example, the system information data 406 may include identification of the products used by the customer. In one example, the system information is provided through machine-to-machine telemetry in which products of the customer are locally and/or remotely monitored.

The AI/ML customer intent model 402 may also consume the customer's browsing history. In one example, the browsing history may indicate that the customer intends to seek the service of a product. In another example, the browsing history may indicate that the customer intends to purchase a product. In another example, the browsing history may indicate that the customer intends to obtain articles and/or white papers relating to a product. In certain embodiments, the customer browsing history 408 may include data relating to the customer's browsing activity occurring during an initial portion of the customer's session with the customer service site. For example, the customer's initial browsing activity may indicate that the customer is already engaging the customer service site with an intent that can be derived from the first set of webpages initially accessed by the customer.

In certain embodiments, AI/ML customer intent model 402 may consume historical resolution data 410. Exemplary historical resolution data 410 may include data regarding the types of issues previously presented and/or handled by the customer and the manner in which they were resolved and/or reasons they were not resolved.

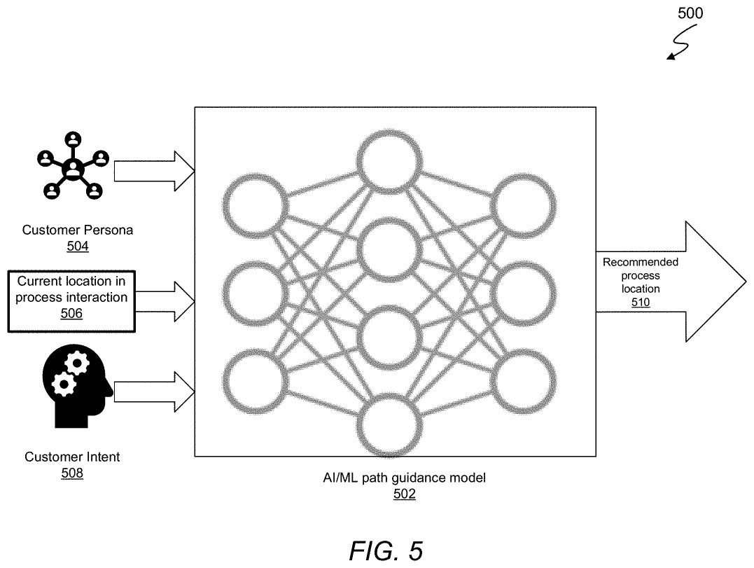

FIG. 5 is a functional diagram 500 depicting the operation of an exemplary embodiment of a trained AI/ML path guidance model 502. In certain embodiments, the AI/ML path guidance model 502 consumes data that may be used to recommend locating the customer at one or more processes in a fixed process path. In one example, the recommended processes may include skipping and/or adding processed steps along the fixed path. Additionally, on the alternative, the recommended processes may include traversing the current fixed path to join a process along a different fixed path. In certain embodiments, the customer may choose which of the recommended process paths the customer desires to travel. Additionally, or in the alternative, the customer may be automatically directed to the recommended process path.

Various types of information may be consumed by the AI/ML path guidance model 502 to provide the recommended the next process location 510 that is tailored to the needs of the customer thereby providing a better experience for the customer than customer service systems that solely provide a fixed path to the customer. The exemplary data shown in FIG. 5 includes one or more of 1) the customer persona 504 of the customer engaging the customer service system, 2) the location 506 at which the customer is currently engaging the process along the process path, and/or 3) the customer intent 508 of the customer.

In the example shown in FIG. 5, it is assumed that the AI/ML path guidance model 502 has been trained using the various fixed paths along which a customer may travel in order to reach a particular resolution (e.g., find product information and/or white papers, submit a service order, purchase a product, self-service in issue the customers having with a product, etc.). In such instances, the fixed product paths are already defined in the trained AI/ML path guidance model 502 and, in some embodiments, the AI/ML path guidance model 502 need not access an external source identifying the various fixed paths. However, in certain embodiments, the AI/ML path guidance model 502 may be configured to access the various fixed paths from a separate data source that is external to the AI/ML path guidance model 502.

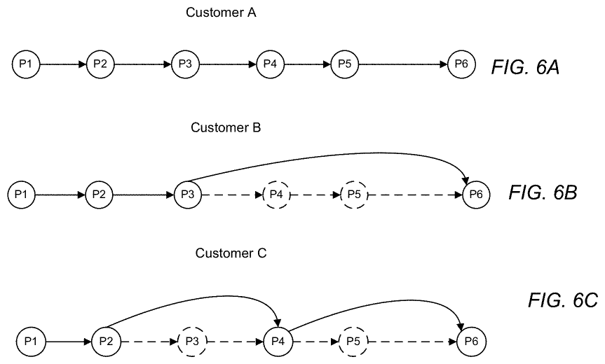

FIG. 6A through FIG. 6C depict various manners in which certain embodiments of the disclosed system direct different customers along a process path. FIG. 6A depicts a linear process path that sequentially proceeds along locations P1=>P2=>P3=>P4=>P5=>P6 that is followed by Customer A.

FIG. 6B depicts the same process path as shown in FIG. 6A, but the AI/ML path guidance model has found that it is desirable to direct Customer B directly from process location P3 to process location P5 of the process path. The resulting process for Customer B, therefore, proceeds along a path defined by process locations P1=>P2=>P3=>P6. The modified path shown in FIG. 6B thus constitutes a path that has been customized for engaging Customer B.

FIG. 6C depicts the same process path as shown in FIG. 6A, but the AI/ML path guidance model has found that it is desirable to direct Customer C directly from process P2 to P4 and from P4 to P6. The resulting process steps taken by Customer C, therefore, proceeds along a path having processes at locations P1=P2=>P4=>P6. P5. The modified path shown in FIG. 6C, therefore, constitutes a path that has been customized for engaging Customer C.

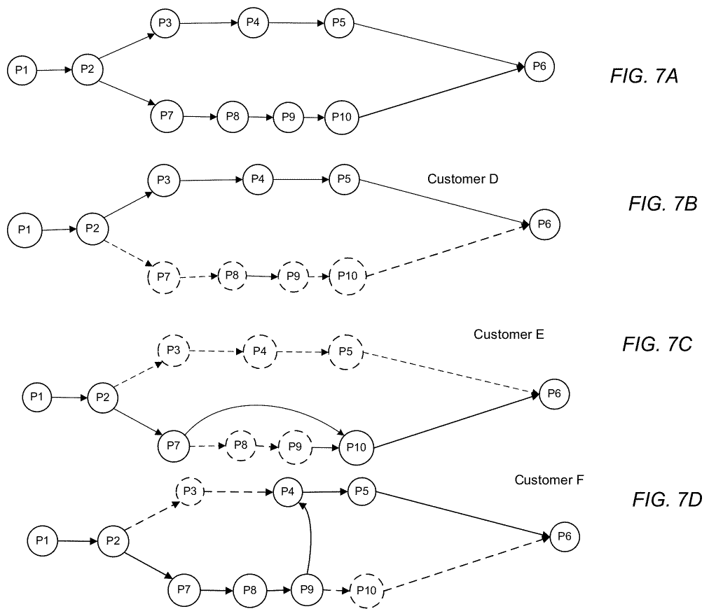

FIG. 7A through FIG. 7D depict various manners in which certain embodiments of the disclosed system direct different customers along a process path. As shown in FIG. 7A, the process path starts at P1 and proceeds to P2, where two branches stem from P2 that ultimately terminate at P6. The first branch includes a path having processes at locations P2=>P3=>P4=>P5=>P6 while the second branch includes a path having processes at locations P2=>P7=>P8=>P9=>P10=>P6. In certain embodiments, the customer selects the branch that the customer will travel, and may make that decision at location P2 of the process path. In one example, a customer may elect to pursue a path along the first branch, while another customer may elect to pursue a path along the second branch. In each instance, however, the customer makes a selection that is not necessarily tailored to the customer's needs.

FIG. 7B depicts a process path that is customized to the needs of Customer D. In this example, the AI/ML path guidance model has found that it is desirable to direct Customer D along the first branch. The path taken by Customer D therefore includes processes at locations P1=>P2=>P3=>P4=>P5=>P6. The modified path shown in 7B, therefore, constitutes a path that has been customized for engaging Customer D.

FIG. 7C depicts a process path that is customized to the needs of Customer E. In this example, the AI/ML path guidance model has found that it is desirable to direct Customer E along a customized version of the second branch. More particularly, although Customer E enters the second branch at process location P7, the AI/ML path guidance model customizes the second branch by directing Customer E from the process at location P9 directly to the process at location P10. As such, the customized path for engaging Customer E includes processes at locations P1=>P2=>P7=>P10=>P6.

FIG. 7 D depicts a process path that is customized for Customer F. In this example, the AI/ML path guidance model initially directs Customer F along the second branch. However, the path along the second branch is modified to transition to the processes executed at locations of the first branch. In this example, after Customer F enters the process path at location P7, Customer F proceeds along processes at the locations of the second branch until reaching the process at location P9, at which point Customer F is directed to the process at location P4 of the first branch. As such, although there are two fixed paths between processes at locations P2 and P6, the AI/ML path guidance model establishes a path that includes two otherwise fixed paths. The path taken by Customer F therefore includes processes at locations P1=>P2=>P7=>P7=>P8=>P9=>P4=>P5=>P6. The modified path shown in 7E, therefore, constitutes a path that has been customized for engaging Customer E.

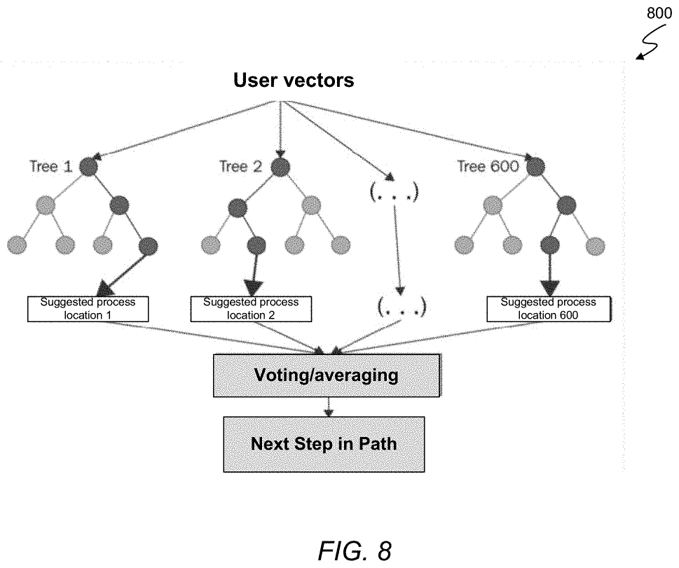

The AI/ML models may be implemented using any number of algorithms including, but not limited to, algorithms used in the development of a neural network and algorithms used in the development of a Random Forest model. FIG. 8 depicts a Random Forest model 800 that may be used to implement, for example, the AI/ML path guidance model. In this example, user vectors representing the customer persona, current location in the process interaction, and customer intent are provided to the Random Forest model 800. Tree 2 of the Random Forest model 800 executes operations that result in a suggested process location 2. The Random Forest model 800 may have any number of trees depending on the needed accuracy and available processing power. In this example, the number of trees go up to Tree 600, which executes operations that result in the suggested process location 600. It will be recognized that the same process location may be suggested by multiple trees. The outputs of the trees are therefore subject to a voting/averaging technique in which the process location having the highest occurrence in the suggested processes of the trees is used to guide the customer to the next step in a guided path.

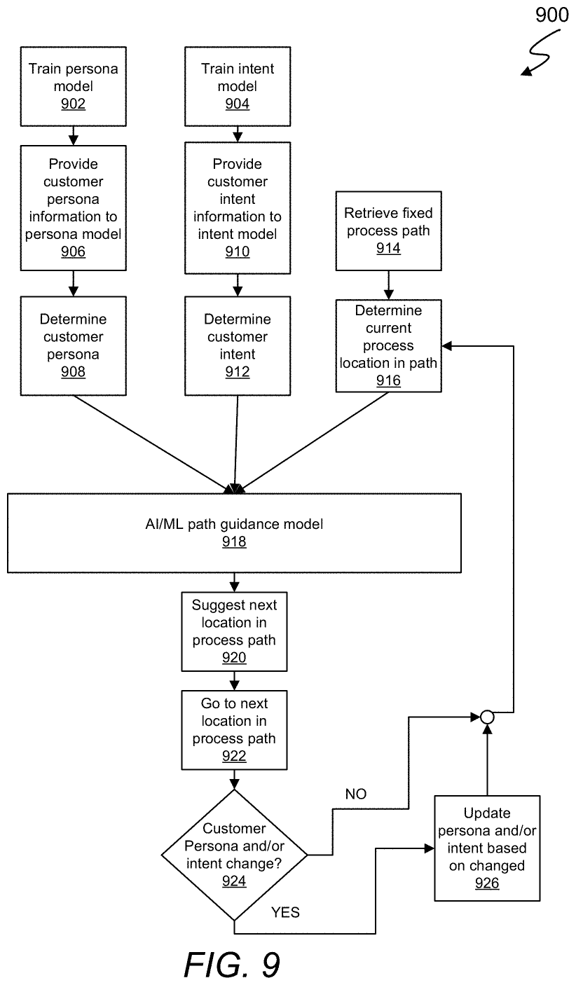

FIG. 9 is a flowchart 900 showing exemplary operations that may be executed in certain embodiments of the disclosed system. In the example shown in FIG. 9, the persona model is trained at 902 and the intent model is trained at 904. Customer persona information for a customer engaging the customer service system is provided to the persona model at 906 and the persona model determines the customer persona at 908. Intent information for the customer engaging the customer service system is provided to the intent model at 910, and the customer intent is determined at 912. In certain embodiments, the fixed process is retrieved at 914 and a determination is made at 916 on location along the process path at which the customer is currently engaged.

In certain embodiments, the customer persona determined by the persona model, the customer intent determined by the intent model, and the process location in the path at which the customer is currently engaged are provided at 918 to an AI/ML path guidance model. The AI/ML path guidance model suggests the next location in the process path that the customer should engage at 920. The customer is directed to the next location suggested by the AI/ML path guidance model at 922. In certain embodiments, the customer may be given the option to proceed to the next location suggested at 922. In such embodiments, the customer may be presented with an option to continue on the current process path or the customized process path. Additionally, or on the alternative, the customer may be automatically directed to the location in the process path suggested at 920.

In certain embodiments, a determination is made at 924 as to whether the customer persona information and/or customer intent have changed based on, for example, the moved to the next location in the process path established at 924. If the persona information and/or intent-based data has changed, it may be updated at 926 before proceeding to the determination of the location of the customer in the process path at 916. In response to the decision at 924, the customer persona may be updated at 906 and the customer intent may be updated at 910. If the customer persona and/or intent information has not changed, certain embodiments may proceed to determine the current process location in the path at 916. Operations may proceed in this manner until such time as the customer reaches a resolution of the customer's intent or otherwise falls out.

The example systems and computing devices described herein are well adapted to attain the advantages mentioned as well as others inherent therein. While such systems have been depicted, described, and are defined by reference to particular descriptions, such references do not imply a limitation on the claims, and no such limitation is to be inferred. The systems described herein are capable of considerable modification, alteration, and equivalents in form and function, as will occur to those ordinarily skilled in the pertinent arts in considering the present disclosure. The depicted and described embodiments are examples only and are in no way exhaustive of the scope of the claims.

Such example systems and computing devices are merely examples suitable for some implementations and are not intended to suggest any limitation as to the scope of use or functionality of the environments, architectures, and frameworks that can implement the processes, components and features described herein. Thus, implementations herein are operational with numerous environments or architectures and may be implemented in general purpose and special-purpose computing systems, or other devices having processing capability. Generally, any of the functions described with reference to the figures can be implemented using software, hardware (e.g., fixed logic circuitry), or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components, and modules described herein may be implemented by a computer program product.

The foregoing thus describes embodiments including components contained within other components (e.g., the various elements shown as components of computer system X210). Such architectures are merely examples, and, in fact, many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation. As such, the various embodiments of the systems described herein via the use of block diagrams, flowcharts, and examples. It will be understood by those within the art that each block diagram component, flowchart step, operation and/or component illustrated by the use of examples can be implemented (individually and/or collectively) by a wide range of hardware, software, firmware, or any combination thereof.

The systems described herein have been described in the context of fully functional computer systems; however, those skilled in the art will appreciate that the systems described herein are capable of being distributed as a program product in a variety of forms, and that the systems described herein apply equally regardless of the particular type of computer-readable media used to actually carry out the distribution. Examples of computer-readable media include computer-readable storage media, as well as media storage and distribution systems developed in the future.

The above-discussed embodiments can be implemented by software modules that perform one or more tasks associated with the embodiments. The software modules discussed herein may include script, batch, or other executable files. The software modules may be stored on a machine-readable or computer-readable storage media such as magnetic floppy disks, hard disks, semiconductor memory (e.g., RAM, ROM, and flash-type media), optical discs (e.g., CD-ROMs, CD-Rs, and DVDs), or other types of memory modules. A storage device used for storing firmware or hardware modules in accordance with an embodiment can also include a semiconductor-based memory, which may be permanently, removably or remotely coupled to a microprocessor/memory system. Thus, the modules can be stored within a computer system memory to configure the computer system to perform the functions of the module. Other new and various types of computer-readable storage media may be used to store the modules discussed herein.

In light of the foregoing, it will be appreciated that the foregoing descriptions are intended to be illustrative and should not be taken to be limiting. As will be appreciated in light of the present disclosure, other embodiments are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the claims. Variations and modifications of the embodiments disclosed herein can be made based on the description set forth herein, without departing from the scope of the claims, giving full cognizance to equivalents thereto in all respects.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A computer-implemented method for intelligently guiding a customer along a service engagement path, the method comprising:
determining a customer persona for the customer;
determining a current location of the customer in a process interaction along the service engagement path;
providing customer persona of the customer and current location of the customer along the service engagement path to an Artificial Intelligence/Machine Learning (AI/ML) path guidance model;
receiving intelligent guidance data from the AI/ML path guidance model, wherein the intelligent guidance data corresponds to a suggested location along the service engagement path based on the customer persona and current location of the customer along the service engagement path; and
directing the customer to the suggested location in the service engagement path.

2. The computer-implemented method of claim 1, further comprising:
determining a customer intent for engaging the service engagement path; and
providing the customer intent, customer persona, and current location of the customer and the service engagement path to the AI/ML path guidance model to generate the intelligent guidance data.

3. The computer-implemented method of claim 2, wherein the customer intent is determined by an AI/ML customer intent model configured to determine customer intent based on one or more of:
customer browsing history;
customer system information;
machine-to-machine telemetry between customer systems; and
past resolutions of problems encountered by the customer.

4. The computer-implemented method of claim 1, wherein
the customer persona corresponds to classifications identified in an unsupervised learning operation executed on historical customer service transaction data.

5. The computer-implemented method of claim 4, wherein
the historical customer service transaction data includes one or more of:
customer entity types;
customer browsing histories;
time spent on a given set of webpages by customers;
page fallouts;
customer survey results;
service paths taken by customers; and
customer problems; and
problem solutions.

6. The computer-implemented method of claim 1, wherein
the service engagement path includes locations at which various communication channels are used by the customer to contact an entity for a service request.

7. The computer-implemented method of claim 1, wherein
the intelligent guidance data from the AI/ML path guidance model corresponds to a suggested location along a further service engagement path that is discontinuous with the service engagement path on which the customer is located.

8. A computer system comprising:
one or more information handling systems, wherein the one or more information handling systems include:
a processor;
a data bus coupled to the processor; and
a non-transitory, computer-readable storage medium embodying computer program code, the non-transitory, computer-readable storage medium being coupled to the data bus;
wherein the computer program code included in one or more of the information handling systems is executable by the processor of the information handling system so that the information handling system, alone or in combination with other information handling systems, executes operations comprising:
determining a current location of a customer in a process interaction along a service engagement path;
providing customer persona of the customer and current location of the customer along the service engagement path to an Artificial Intelligence/Machine Learning (AI/ML) path guidance model;
receiving intelligent guidance data from the AI/ML path guidance model, wherein the intelligent guidance data corresponds to a suggested location along the service engagement path based on the customer persona and current location of the customer along the service engagement path; and
directing the customer to the suggested location in the service engagement path.

9. The system of claim 8, further wherein the operations further comprise:
determine a customer intent for engaging the service engagement path; and
provide the customer intent, customer persona, and current location of the customer and the service engagement path to the AI/ML path guidance model to generate the intelligent guidance data.

10. The system of claim 9, wherein
the customer intent is determined by an AI/ML customer intent model configured to determine customer intent based on one or more of:
customer browsing history;
customer system information;
machine-to-machine telemetry between customer systems; and
past resolutions of problems encountered by the customer.

11. The system of claim 8, wherein
the customer persona corresponds to classifications identified in an unsupervised learning operation executed on historical customer service transaction data.

12. The system of claim 11, wherein
the historical customer service transaction data includes one or more of:
customer entity types;
customer browsing histories;
time spent on a given set of webpages by customers;
page fallouts;
customer survey results;
service paths taken by customers; and
customer problems; and
problem solutions.

13. In the system of claim 8, wherein
the service engagement path includes locations at which various communication channels are used by the customer to contact an entity for a service request.

14. The system of claim 8, wherein
the intelligent guidance data from the AI/ML path guidance model corresponds to a suggested location along a further service engagement path that is discontinuous with the service engagement path on which the customer is located.

15. A non-transitory, computer-readable storage medium embodying computer program code, the computer program code comprising computer executable instructions configured for:
determining a current location of a customer in a process interaction along a service engagement path;
providing customer persona of the customer and current location of the customer along the service engagement path to an Artificial Intelligence/Machine Learning (AI/ML) path guidance model;
receiving intelligent guidance data from the AI/ML path guidance model, wherein the intelligent guidance data corresponds to a suggested location along the service engagement path based on the customer persona and current location of the customer along the service engagement path; and
directing the customer to the suggested location in the service engagement path.

16. The non-transitory, computer-readable storage medium of claim 15, wherein the instructions are further operable to:
determine a customer intent for engaging the service engagement path; and
provide the customer intent, customer persona, and current location of the customer and the service engagement path to the AI/ML path guidance model to generate the intelligent guidance data.

17. The non-transitory, computer-readable storage medium of claim 16, wherein
the customer intent is determined by an AI/ML customer intent model configured to determine customer intent based on one or more of:
customer browsing history;
customer system information;
machine-to-machine telemetry between customer systems; and
past resolutions of problems encountered by the customer.

18. The non-transitory, computer-readable storage medium of claim 15, wherein
the customer persona corresponds to classifications identified in an unsupervised learning operation executed on historical customer service transaction data.

19. The non-transitory, computer-readable storage medium of claim 18, wherein
the historical customer service transaction data includes one or more of:
customer entity types;
customer browsing histories;
time spent on a given set of webpages by customers;
page fallouts;
customer survey results;
service paths taken by customers; and
customer problems; and
problem solutions.

20. The non-transitory, computer-readable storage medium of claim 15, wherein
the service engagement path includes locations at which various communication channels are used by the customer to contact an entity for a service request.
